(19) United States
(12) Patent Application Publication
(10) Pub. No.: US 2011/0291046 A1
(43) Pub. Date: Dec. 1, 2011

(54) SILICONE POLYMER DESICCANT COMPOSITION AND METHOD OF MAKING THE SAME

(75) Inventors: Louis Patrone, Hamburg, NY (US); Samuel A. Incorvia, North Tonawanda, NY (US)

(73) Assignee: Multisorb Technologies, Inc., Buffalo, NY (US)

(21) Appl. No.: 13/116,774

(22) Filed: May 26, 2011

Related U.S. Application Data
(60) Provisional application No. 61/348,603, filed on May 26, 2010.

(51) Int. Cl. C08L 83/04; C08K 3/22; C09K 3/00

(52) U.S. Cl. 252/194

(57) ABSTRACT

A molded article including a blend of a self supporting silicone polymer and a sorbent, wherein the sorbent is homogeneously dispersed within the silicone polymer. A method of forming a molding composition including a silicone polymer and a sorbent, wherein the silicone polymer includes a first silicone material and a second silicone material, the first silicone material being different than the second silicone material, the method including the steps of: a) blending the first silicone material and the sorbent into a first blended composition, wherein the sorbent is homogeneously dispersed within the first silicone material; b) blending the second silicone material and the sorbent into a second blended composition, wherein the sorbent is homogeneously dispersed within the second silicone material; and, c) blending the first and second blended composition to form the molding composition, wherein the sorbent is homogeneously dispersed within the molding composition and the molding composition is heat curable.

### CROSS-REFERENCE TO RELATED APPLICATIONS

This patent application claims the benefit under 35 U.S.C. §119(e) of U.S. Provisional Patent Application No. 61/348,603, filed May 26, 2010, which application is incorporated herein by reference.

### FIELD OF THE INVENTION

The present invention relates generally to a silicone polymer sorbent composition, and more particularly, to a method of forming a silicone resin or silicone rubber based silicone polymer sorbent composition and articles of manufacture fabricated therefrom comprising adsorbing additives in a silicone resin or silicone rubber base.

### BACKGROUND OF THE INVENTION

Silicone polymers are substantially chemically inert, synthetic compounds used in a variety of applications. Silicone polymer compounds typically provide heat resistance, rubber-like qualities, electrical insulation, sealant capabilities, resistance to oxidation, low toxicity and high gas permeability, to name but a few qualities. Due to silicone polymer's inert nature and other beneficial qualities, it may be used in a variety of applications ranging from kitchen items to medically implantable devices.

Known resin and sorbent compositions provide suitable moistures barriers; however, such compositions may be slow to respond to water vapor and therefore unsuitable in applications where rapid uptake of water vapor is required. Some known compositions are disclosed in U.S. Pat. No. 7,595,278 and U.S. patent application Ser. No. 11/635,750, which patent and patent application are incorporated by reference herein.

### BRIEF SUMMARY OF THE INVENTION

The present invention broadly comprises a molded article including a blend of a self supporting silicone polymer and a sorbent, wherein the sorbent is homogeneously dispersed within the silicone polymer.

In a further embodiment, the present invention broadly comprises a molding composition including a silicone component and a sorbent, wherein the sorbent is homogeneously dispersed within the silicone component.

In still yet a further embodiment, the present invention broadly comprises a method of forming a molding composition including a silicone polymer and a sorbent, wherein the silicone polymer includes a first silicone material and a second silicone material, the first silicone material being different than the second silicone material. The method includes the steps of: a) blending the first silicone material and the sorbent into a first blended composition, wherein the sorbent is homogeneously dispersed within the first silicone material; b) blending the second silicone material and the sorbent into a second blended composition, wherein the sorbent is homogeneously dispersed within the second silicone material; and, c) blending the first and second blended composition to form the molding composition, wherein the sorbent is homogeneously dispersed within the molding composition and the molding composition is heat curable.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of an o-ring formed from the present invention silicone polymer desiccant composition;

FIG. 2 is a perspective view of an insert formed from the present invention silicone polymer desiccant composition;

FIG. 3 is a perspective view of a washer, which may also referred to as a gasket, formed from the present invention silicone polymer desiccant composition; and,

FIG. 4 is a cross sectional view of an air bag inflation device having the washer shown in FIG. 3 disposed therein.

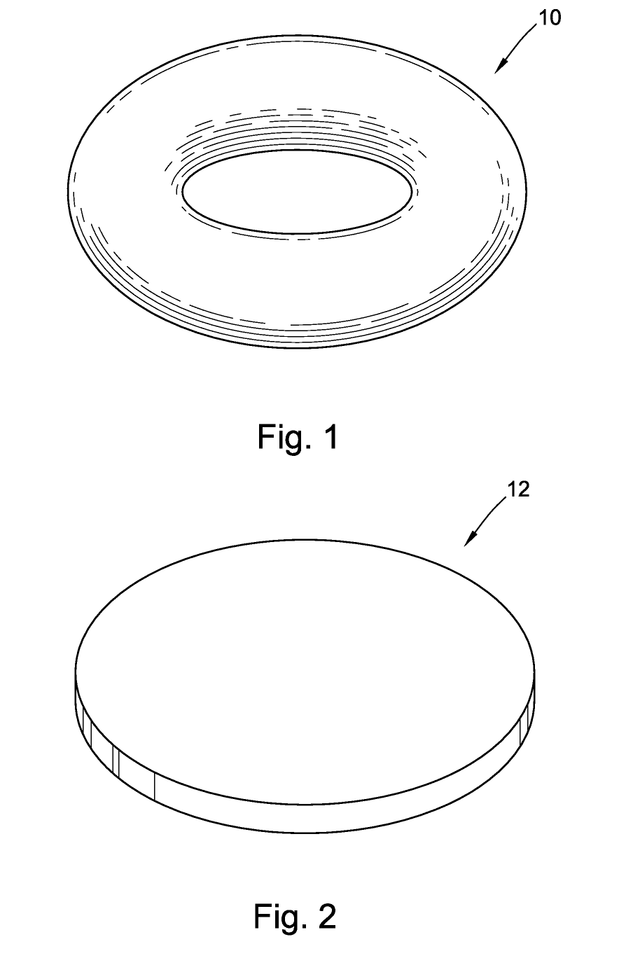

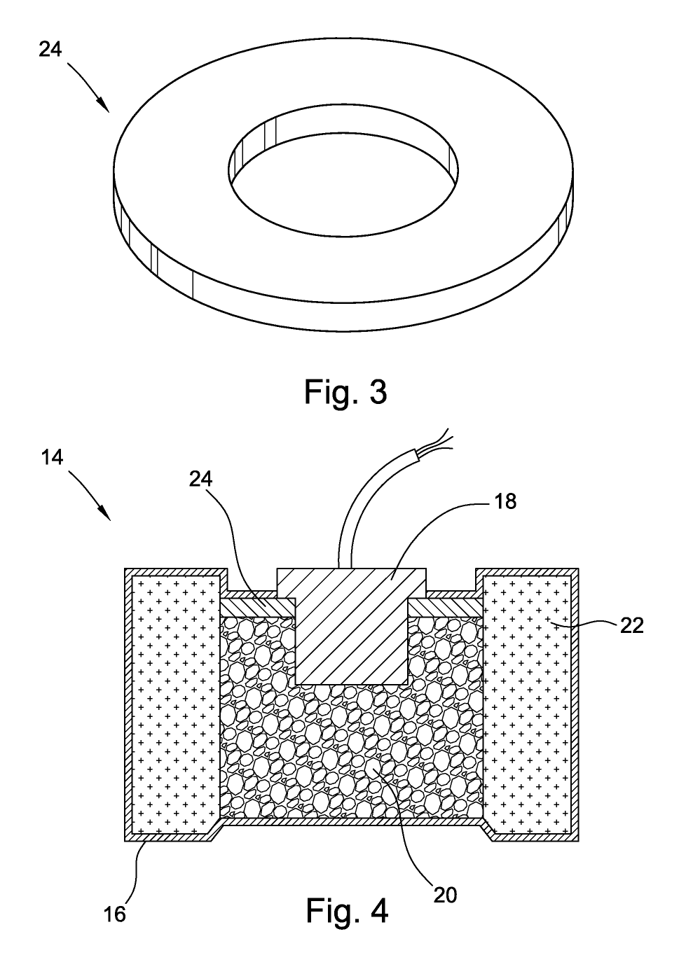

### DETAILED DESCRIPTION OF THE INVENTION

It is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

As one of ordinary skill in the art appreciates, the term “fluid” is defined as an aggregate of matter in which the molecules are able to flow past each other without limit and without fracture planes forming. “Fluid” can be used to describe, for example, liquids, gases and vapors. Additionally, a salt of a CO₂ releasing anion as used herein refers to any salt that will release CO₂ vapor upon contact with an acid stronger than carbonic acid, e.g., carbonates and bicarbonates. “Vapor permeability” as used herein refers to the rate of permeability, independent of the actual permeability of any vapor or gas, except water, through a material. When the term “permeable” or “impermeable” is used herein, it is intended to refer to transfer of fluid through a material either through pores therein or at a molecular level. “Self supporting” as used herein refers to retaining substantially the same dimensions over an extended period of time, e.g., at least one month, without necessity to be bound to another structure or surface.

It has been found that silicone polymers in the form of silicone resin and silicone rubber/elastomer are particularly useful for applications wherein a desiccant is homogeneously dispersed throughout the resin or rubber. Silicone is intended to broadly mean a fluid, resin or elastomer, which can be a grease, rubber, or foamable powder. Moreover, silicone is the group name for heat-stable, water repellent, semiorganic polymers of organic radicals attached to the silicones, for example, dimethyl silicone. Furthermore, it should be appreciated that silicone resin is intended to broadly include but not be limited to a type of silicone material which is formed by branched, cage-like oligosiloxanes with the general formula of RₙSiXₘO_{y}, where R is a non-reactive substituent, e.g., methyl or phenyl group, and X is a functional group, e.g., hydrogen, hydroxyl, chlorine or alkoxy group. The foregoing groups may be highly crosslinked to form insoluble polysiloxane structures. Moreover, when R is a methyl group, four possible functional siloxane monomeric units include but are not limited to Me₃SiO, Me₂SiO₂, MeSiO₃ and SiO₄. Typically, silicone resins are formed by hydrolytic condensation of various silicone precursors. Some starting materials used in the formation of silicone resins include but are not limited to sodium silicate, chlorosilane, tetraethoxysilane, ethyl polysilicate, dimethyldichlorosilane and disiloxanes. Contrarily, silicone rubber is intended to broadly include but not be limited to a rubber-like material composed of silicone which is vulcanized through the introduction of heat. The vulcanization process may include more than one stage, e.g., heating to form a shape followed by a prolonged post-curing process. Silicone rubber can be colored and may further be extruded into tubes, strips, cords, etc., and such applications may be further used to form gaskets and o-rings.

Some silicone polymers are formed by combining two or more components thereby resulting in a composition that may be crosslinked, cured or vulcanized. For example, a silicone polymer may be formed from first and second silicone materials. The first silicone material may be an alkyl silicone polymer, e.g., methyl silicone, and the second silicone material may be a vinyl silicone polymer. The combination of the first and second silicone polymers is heat curable which may be accelerated with a catalyst such as platinum. Such a combination and curing process is depicted herebelow.

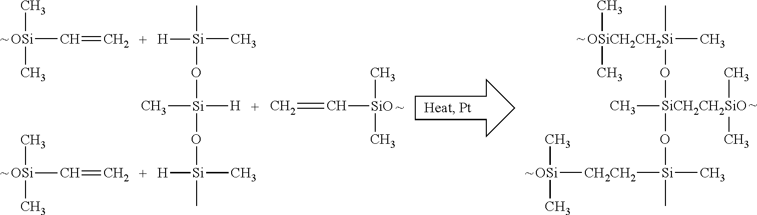

The present invention comprises a silicone polymer or component due to the variety of beneficial characteristics provided by silicone resin and silicone rubber. For example, although silicone resin provides a barrier to liquid water, silicone resin is water vapor permeable. Silicone resin is resilient which permits its application as a reusable sealing material. Additionally, silicone resin can withstand exposure to elevated temperature ranges which would cause other thermoplastic and thermoset resins to breakdown.

According to the present invention, a desiccant material, e.g., molecular sieve, silica gel, an ion exchange resin, activated carbon, activated alumina, clay, zeolite, particulate metal, a salt comprising a CO₂ releasing anion, calcium oxide and mixtures thereof, may be added to the separate components used to form the silicone resin or rubber, may be added to a single component or may be added to the combination of components after they have themselves been combined. A preferred embodiment, which is believed to result in substantially all of the desiccant particles being discrete desiccant particles each fully surrounded by silicone material, comprises introducing and mixing desiccant particles into each component used to form the silicone polymer, mixing together the components including desiccant to form a composition and subsequently crosslinking the composition to form a silicone resin or silicone rubber with sorbent. It should be appreciated that depending on the desired final article, the homogeneous composition may be injection molded, or otherwise formed to a shape, e.g., sheet, tube, plug, etc., prior to and/or during the crosslinking step.

In order for a liquid injection molding process to be implemented, several mechanical components must be in place. Typically, a molding machine requires a metered pumping device in conjunction with an injection unit to which a dynamic or static mixer is attached. An integrated system can aid in precision and process efficiency. The critical components of a liquid injection molding machine include: injectors, metering units, supply drums, mixers, nozzles and mold clamps. Although the foregoing components are identified as critical, it should be appreciated that other injection molding arrangements are also possible and such arrangements are within the spirit and scope of the present invention.

An injector or an injecting device is responsible for pressurizing the liquid silicone to aid in the injection of the material into the pumping section of the machine. Pressure and injection rate can be adjusted at the operator's discretion. Metering units pump the two primary liquid materials, i.e., the catalyst and the base forming silicone materials, to ensure that the two materials maintain a constant ratio while being simultaneously released. Supply drums, also called plungers, serve as the primary containers for mixing materials. Both the supply drums and a container of pigment may be connected to the main pumping system. Mixers, e.g., static or dynamic, combine materials together after the components exit the metering units. Once combined, pressure is used to drive the mixture into a designated mold, extrusion device, etc. A nozzle is typically used to facilitate the deposition of the mixture into the mold. Often, the nozzle features an automatic shut-off valve to help prevent leaking and/or overfilling the mold. Lastly, mold clamps are used to secure the mold during the injection molding process, and open the mold upon completion.

Broadly, an example of an injection molding process using the present invention can be described as follows. Liquid silicone components are supplied in barrels, wherein each component has a homogeneously dispersed desiccant mixed therein. The two components are pumped through a static mixer by a metering pump. One of the components contains the catalyst, which is typically platinum based; however, may be any catalyst known in the art. If desired, a coloring paste as well as other additives can also be added before the material enters the static mixer section. In the static mixer, the components are well mixed and subsequently transferred to a cooled metering section of the injection molding machine. The static mixer renders a very homogeneous material that results in products which are not only very consistent throughout the molded article, but also from article to article. It should be appreciated that the foregoing example of an injection molding process is but one embodiment of the present invention and other processes may also be used, e.g., an extrusion process.

The following examples represent performance characteristics of cross-linked silicone resins loaded with 13x molecular sieve desiccant and calcium oxide (CaO) desiccant.

### EXAMPLE 1

10 grams of UOP Type 13x Molecular Sieve (Advanced Specialty Glass Equipment, Item No. MS-1330, Lot No. 2011007388) was added to 18 grams of a low durometer liquid silicone rubber (Shin-Etsu Silicones, Product ID No. KE-2004-10A), and the two components were then mixed until they formed a uniform, i.e., homogeneous, first mixture. Then, 10 grams of UOP Type 13x Molecular Sieve (Advanced Specialty Glass Equipment, Item No. MS-1330, Lot No. 2011007388) was added to 18 grams of a low durometer liquid silicone rubber (Shin-Etsu Silicones, Product ID No. KE-2004-10B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was formed into a thin sheet and placed in an oven at 248° F. to cure, i.e., crosslink, for 1 hour. Following crosslinking, the final composition was tested for water adsorption in an environment comprising approximately 80% relative humidity (RH). Table 1 below summarizes the water adsorption over several days. The water adsorption is represented in the form of percent water by weight.

TABLE 1

| Date | Time of day | Mass (grams) | % Water (% H₂O) |
|---|---|---|---|
| Apr. 27, 2010 | 6:30 am | 2.8925 | 0.00 |
| Apr. 28, 2010 | 6:20 am | 3.0735 | 6.25 |
| Apr. 29, 2010 | 6:30 am | 3.0718 | 6.23 |
| Apr. 30, 2010 | 6:30 am | 3.0730 | 6.24 |
| May 03, 2010 | | 3.0727 | 6.79 |

The theoretical maximum adsorption of water was calculated according to the following formula (1):

ad_{comp}=(mᵢ)×(dl)×(adₘₐₓ) (1)

wherein: ad_{comp} is the theoretical maximum mass of water adsorbed by the final crosslinked composition;
mᵢ is the total starting mass of the final composition after crosslinking;
dl is the percentage of desiccant loading in the final composition; and,
adₘₐₓ is the theoretical maximum percent by weight adsorption of water by the desiccant.

Thus, in the foregoing example, having approximately 35.7% desiccant loading and a 20% theoretical maximum percent by weight adsorption of water by the desiccant, the maximum mass the sample could attain is 3.0950 g. It was found that the moisture uptake rate was faster than expected and this is believed to be due to air bubbles being present within the final crosslinked composition.

### EXAMPLE 2

8 grams of UOP Type 13x Molecular Sieve (Advanced Specialty Glass Equipment, Item No. MS-1330, Lot No. 2011007388) was added to 12.5 grams of a liquid silicone rubber (Shin-Etsu Silicones, Product ID No. KE-1950-20A), and the two components were then mixed until they formed a uniform, i.e., homogeneous, first mixture. Then, 8 grams of UOP Type 13x Molecular Sieve (Advanced Specialty Glass Equipment, Item No. MS-1330, Lot No. 2011007388) was added to 12.5 grams of a liquid silicone rubber (Shin-Etsu Silicones, Product ID No. KE-1950-20B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was formed into a thin sheet and placed in an oven at 302° F. to cure, i.e., crosslink, for 1 hour. Following crosslinking, the final composition was tested for water adsorption in an environment comprising approximately 80% relative humidity (RH). Table 2 below summarizes the water adsorption over several days. The water adsorption is represented in the form of percent water by weight.

TABLE 2

| Date | Time of day | Mass (grams) | % Water (% H₂O) |
|---|---|---|---|
| Apr. 27, 2010 | 6:30 am | 2.8442 | 0.0 |
| Apr. 28, 2010 | 6:20 am | 3.0502 | 7.2 |
| Apr. 29, 2010 | 6:30 am | 3.0500 | 7.2 |
| Apr. 30, 2010 | 6:30 am | 3.0511 | 7.3 |
| May 03, 2010 | | 3.0523 | 7.3 |

Using equation (1) above, in the foregoing example, having approximately 39.0% desiccant loading and a 20% theoretical maximum percent by weight adsorption of water by the desiccant, the maximum mass the sample could attain is 3.066 g. Again, it was found that the moisture uptake rate was faster than expected and this is believed to be due to air bubbles being present within the final crosslinked composition.

### EXAMPLE 3

12 grams of UOP Type 13x Molecular Sieve (Advanced Specialty Glass Equipment, Item No. MS-1330, Lot No. 2011007388) was added to 18 grams of a low durometer liquid silicone rubber (Shin-Etsu Silicones, Product ID No. KE-2004-10A), and the two components were then mixed until they formed a uniform, i.e., homogeneous, first mixture. Then, 12 grams of UOP Type 13x Molecular Sieve (Advanced Specialty Glass Equipment, Item No. MS-1330, Lot No. 2011007388) was added to 18 grams of a low durometer liquid silicone rubber (Shin-Etsu Silicones, Product ID No. KE-2004-10B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was formed into a thin sheet and placed in an oven at 248° F. to cure, i.e., crosslink, for 1 hour. Following crosslinking, the final composition was tested for water adsorption in an environment comprising approximately 80% relative humidity (RH). Table 3 below summarizes the water adsorption over several days. The water adsorption is represented in the form of percent water by weight.

TABLE 3

| Date | Time of day | Mass (grams) | % Water (% H₂O) |
|---|---|---|---|
| May 03, 2010 | 8:00 am | 10.8335 | 0.00 |
| May 03, 2010 | 11:00 am | 11.0863 | 6.26 |
| May 03, 2010 | 1:00 pm | 11.1098 | 6.48 |
| May 04, 2010 | 7:00 am | 11.1160 | 6.54 |
| May 05, 2010 | 1:30 pm | 11.1177 | 6.56 |

Using equation (1) above, in the foregoing example, having approximately 40.0% desiccant loading and a 20% theoretical maximum percent by weight adsorption of water by the desiccant, the maximum mass the sample could attain is 11.2682 g.

### EXAMPLE 4

37.33 grams of calcium oxide (CaO) (Specialty Minerals Inc., Item No. 02-01392AH01) was added to 335 grams of a low durometer liquid silicone rubber, i.e., 10 durometer, (Shin-Etsu Silicones, Product ID No. KE-2004-10A), and the two components were then mixed until they formed a uniform, i.e., homogeneous, first mixture. Then, 37.33 grams of calcium oxide (CaO) (Specialty Minerals Inc., Item No. 02-01392AH01) was added to 335 grams of a low durometer liquid silicone rubber (Shin-Etsu Silicones, Product ID No. KE-2004-10B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was then fed into a Liquid Injection Molding System having the following settings: injection rate=3 inches/second; cure time=60-80 seconds; and, hold temperature=400° F. Passing the final composition through the molding system and curing the composition at the hold temperature for the cure time resulted in the crosslinking of the silicone composition. Following crosslinking, the final composition was tested for water adsorption in an environment comprising approximately 80% relative humidity (RH). Table 4 below summarizes the water adsorption over several days for three samples having approximately 10% by weight CaO, i.e., S1, S2 and S3. The water adsorption is represented in the form of percent water by weight.

TABLE 4

| | Time of | Mass S1 | % Water | Mass S2 | % Water | Mass S3 | % Water |
|---|---|---|---|---|---|---|---|
| Date | day | (grams) | (% H₂O) | (grams) | (% H₂O) | (grams) | (% H₂O) |
| Feb. 17, 2011 | 8:30 am | 2.0858 | 0.00 | 2.0840 | 0.00 | 2.0487 | 0.00 |
| Feb. 17, 2011 | 1:30 pm | 2.0924 | 0.32 | 2.0904 | 0.31 | 2.0547 | 0.29 |
| Feb. 18, 2011 | 7:00 am | 2.1254 | 1.90 | 2.1232 | 1.88 | 2.0871 | 1.87 |
| Feb. 22, 2011 | 9:30 am | 2.1508 | 3.12 | 2.1480 | 3.07 | 2.1110 | 3.04 |
| Feb. 23, 2011 | 7:30 am | 2.1511 | 2.13 | 2.1492 | 3.13 | 2.1113 | 3.06 |
| Feb. 24, 2011 | 10:30 am | 2.1515 | 3.15 | 2.1491 | 3.12 | 2.1118 | 3.08 |
| Feb. 28, 2011 | 9:00 am | 2.1524 | 3.19 | 2.1500 | 3.17 | 2.1123 | 3.10 |
| Mar. 01, 2011 | 6:30 am | 2.1525 | 3.20 | 2.1501 | 3.17 | 2.1123 | 3.10 |
| Mar. 02, 2011 | 8:30 am | 2.1526 | 3.20 | 2.1501 | 3.17 | 2.1128 | 3.13 |
| Mar. 07, 2011 | 9:30 am | 2.1555 | 3.34 | 2.1531 | 3.32 | 2.1151 | 3.24 |
| Mar. 08, 2011 | 1:30 pm | 2.1566 | 3.39 | 2.1537 | 3.34 | 2.1157 | 3.27 |
| Mar. 09, 2011 | 8:30 am | 2.1569 | 3.41 | 2.1542 | 3.37 | 2.1162 | 3.29 |
| Mar. 14, 2011 | 11:00 am | 2.1587 | 3.50 | 2.1561 | 3.46 | 2.1185 | 3.41 |
| Mar. 15, 2011 | 11:00 am | 2.1596 | 3.54 | 2.1572 | 3.51 | 2.1193 | 3.45 |
| Mar. 24, 2011 | 6:30 am | 2.1622 | 3.66 | 2.1597 | 3.63 | 2.1217 | 3.56 |
| Mar. 27, 2011 | 6:30 am | 2.1627 | 3.69 | 2.1605 | 3.67 | 2.1222 | 3.59 |
| Mar. 31, 2011 | 9:00 am | 2.1633 | 3.72 | 2.1611 | 3.70 | 2.1230 | 3.63 |
| Apr. 03, 2011 | 10:30 am | 2.1643 | 3.76 | 2.1618 | 3.73 | 2.1239 | 3.67 |
| Apr. 07, 2011 | 7:30 am | 2.1649 | 3.79 | 2.1622 | 3.75 | 2.1242 | 3.69 |
| Apr. 13, 2011 | 6:30 am | 2.1655 | 3.82 | 2.1632 | 3.80 | 2.1250 | 3.72 |
| Apr. 26, 2011 | 8:00 am | 2.1658 | 3.84 | 2.1635 | 3.81 | 2.1250 | 3.72 |
| May 04, 2011 | 2:00 pm | 2.1657 | 3.83 | 2.1632 | 3.80 | 2.1248 | 3.71 |

Using equation (1) above, in the foregoing example, having approximately 10.0% desiccant loading and a 28% theoretical maximum percent by weight adsorption of water by the desiccant, the maximum mass of water the samples could adsorb is 0.0584 g, 0.0584 g and 0.0574 g for S1, S2 and S3, respectively. The actual weight increase for each sample was 0.0800 g, 0.0795 g and 0.0763 g for S1, S2 and S3, respectively, which is a 38.35%, 38.15% and 37.24% by weight increase S1, S2 and S3, respectively.

### EXAMPLE 5

83.75 grams of calcium oxide (CaO) (Specialty Minerals Inc., Item No. 02-01392AH01) was added to 335 grams of a low durometer liquid silicone rubber, i.e., 10 durometer, (Shin-Etsu Silicones, Product ID No. KE-2004-10A), and the two components were then mixed until they formed a uniform, i.e., homogeneous, first mixture. Then, 83.75 grams of calcium oxide (CaO) (Specialty Minerals Inc., Item No. 02-01392AH01) was added to 335 grams of a low durometer liquid silicone rubber (Shin-Etsu Silicones, Product ID No. KE-2004-10B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was then fed into a Liquid Injection Molding System having the following settings: injection rate=3 inches/second; cure time=60-80 seconds; and, hold temperature=400° F. Passing the final composition through the molding system and curing the composition at the hold temperature for the cure time resulted in the crosslinking of the silicone composition. Following crosslinking, the final composition was tested for water adsorption in an environment comprising approximately 80% relative humidity (RH). Table 5 below summarizes the water adsorption over several days for three samples having approximately 20% by weight CaO, i.e., S4, S5 and S6. The water adsorption is represented in the form of percent water by weight.

TABLE 5

| | Time of | Mass S4 | % Water | Mass S5 | % Water | Mass S6 | % Water |
|---|---|---|---|---|---|---|---|
| Date | day | (grams) | (% H₂O) | (grams) | (% H₂O) | (grams) | (% H₂O) |
| Feb. 17, 2011 | 8:30 am | 2.1572 | 0.00 | 2.1347 | 0.00 | 2.1528 | 0.00 |
| Feb. 17, 2011 | 1:30 pm | 2.1668 | 0.45 | 2.1443 | 0.45 | 2.1627 | 0.46 |
| Feb. 18, 2011 | 7:00 am | 2.2231 | 3.05 | 2.1988 | 3.00 | 2.2187 | 3.06 |
| Feb. 22, 2011 | 9:30 am | 2.2871 | 6.02 | 2.2642 | 6.07 | 2.2827 | 6.03 |
| Feb. 23, 2011 | 7:30 am | 2.2885 | 6.09 | 2.2653 | 6.12 | 2.2842 | 6.10 |
| Feb. 24, 2011 | 10:30 am | 2.2893 | 6.12 | 2.2661 | 6.16 | 2.2850 | 6.14 |
| Feb. 28, 2011 | 9:00 am | 2.2960 | 6.43 | 2.2729 | 6.47 | 2.2916 | 6.45 |
| Mar. 01, 2011 | 6:30 am | 2.2976 | 6.51 | 2.2745 | 6.55 | 2.2932 | 6.52 |
| Mar. 02, 2011 | 8:30 am | 2.2994 | 6.59 | 2.2756 | 6.60 | 2.2957 | 6.64 |
| Mar. 07, 2011 | 9:30 am | 2.3043 | 6.82 | 2.2809 | 6.85 | 2.3006 | 6.87 |
| Mar. 08, 2011 | 1:30 pm | 2.3051 | 6.86 | 2.2820 | 6.90 | 2.3010 | 6.88 |
| Mar. 09, 2011 | 8:30 am | 2.3058 | 6.89 | 2.2823 | 6.91 | 2.3010 | 6.88 |
| Mar. 14, 2011 | 11:00 am | 2.3075 | 6.97 | 2.2845 | 7.02 | 2.3035 | 7.00 |
| Mar. 15, 2011 | 11:00 am | 2.3091 | 7.04 | 2.2857 | 7.07 | 2.3049 | 7.07 |
| Mar. 24, 2011 | 6:30 am | 2.3119 | 7.17 | 2.2888 | 7.22 | 2.3077 | 7.20 |
| Mar. 27, 2011 | 6:30 am | 2.3128 | 7.21 | 2.2897 | 7.26 | 2.3085 | 7.23 |
| Mar. 31, 2011 | 9:00 am | 2.3136 | 7.25 | 2.2906 | 7.30 | 2.3095 | 7.28 |
| Apr. 03, 2011 | 10:30 am | 2.3145 | 7.29 | 2.2911 | 7.33 | 2.3102 | 7.31 |
| Apr. 07, 2011 | 7:30 am | 2.3151 | 7.32 | 2.2920 | 7.37 | 2.3109 | 7.34 |
| Apr. 13, 2011 | 6:30 am | 2.3162 | 7.37 | 2.2930 | 7.42 | 2.3114 | 7.37 |
| Apr. 26, 2011 | 8:00 am | 2.3176 | 7.44 | 2.2944 | 7.48 | 2.3132 | 7.45 |
| May 04, 2011 | 2:00 pm | 2.3185 | 7.48 | 2.2947 | 7.50 | 2.3137 | 7.47 |

Using equation (1) above, in the foregoing example, having approximately 20.0% desiccant loading and a 28% theoretical maximum percent by weight adsorption of water by the desiccant, the maximum mass of water the samples could adsorb is 0.1208 g, 0.1195 g and 0.1206 g for S4, S5 and S6, respectively. The actual weight increase for each sample was 0.1604 g, 0.1597 g and 0.1604 g for S4, S5 and S6, respectively, which is a 37.18%, 37.41% and 37.25% by weight increase S4, S5 and S6, respectively.

### EXAMPLE 6

223.30 grams of calcium oxide (CaO) (Specialty Minerals Inc., Item No. 02-01392AH01) was added to 335 grams of a low durometer liquid silicone rubber, i.e., 10 durometer, (Shin-Etsu Silicones, Product ID No. KE-2004-10A), and the two components were then mixed until they formed a uniform, i.e., homogeneous, first mixture. Then, 223.30 grams of calcium oxide (CaO) (Specialty Minerals Inc., Item No. 02-01392AH01) was added to 335 grams of a low durometer liquid silicone rubber (Shin-Etsu Silicones, Product ID No. KE-2004-10B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was then fed into a Liquid Injection Molding System having the following settings: injection rate=3 inches/second; cure time=60-80 seconds; and, hold temperature=400° F. Passing the final composition through the molding system and curing the composition at the hold temperature for the cure time resulted in the crosslinking of the silicone composition. Following crosslinking, the final composition was tested for water adsorption in an environment comprising approximately 80% relative humidity (RH). Table 6 below summarizes the water adsorption over several days for three samples having approximately 40% by weight CaO, i.e., S7, S8 and S9. The water adsorption is represented in the form of percent water by weight.

TABLE 6

| | Time of | Mass S7 | % Water | Mass S8 | % Water | Mass S9 | % Water |
|---|---|---|---|---|---|---|---|
| Date | day | (grams) | (% H₂O) | (grams) | (% H₂O) | (grams) | (% H₂O) |
| Feb. 17, 2011 | 8:30 am | 2.5295 | 0.00 | 2.5354 | 0.00 | 2.5788 | 0.00 |
| Feb. 17, 2011 | 1:30 pm | 2.5462 | 0.66 | 2.5520 | 0.65 | 2.5957 | 0.66 |
| Feb. 18, 2011 | 7:00 am | 2.6362 | 4.22 | 2.6383 | 4.06 | 2.6850 | 4.12 |
| Feb. 22, 2011 | 9:30 am | 2.8358 | 12.11 | 2.8424 | 12.11 | 2.8937 | 12.21 |
| Feb. 23, 2011 | 7:30 am | 2.8463 | 12.52 | 2.8533 | 12.54 | 2.9044 | 12.63 |
| Feb. 24, 2011 | 10:30 am | 2.8545 | 12.85 | 2.8614 | 12.86 | 2.9125 | 12.94 |
| Feb. 28, 2011 | 9:00 am | 2.8683 | 13.39 | 2.8765 | 13.45 | 2.9284 | 13.56 |
| Mar. 01, 2011 | 6:30 am | 2.8702 | 13.47 | 2.8786 | 13.54 | 2.9309 | 13.65 |
| Mar. 02, 2011 | 8:30 am | 2.8725 | 13.56 | 2.8815 | 13.65 | 2.9336 | 13.76 |
| Mar. 07, 2011 | 9:30 am | 2.8812 | 13.90 | 2.8904 | 14.00 | 2.9443 | 14.17 |
| Mar. 08, 2011 | 1:30 pm | 2.8829 | 13.97 | 2.8923 | 14.08 | 2.9467 | 14.27 |
| Mar. 09, 2011 | 8:30 am | 2.8843 | 14.03 | 2.8944 | 14.16 | 2.9478 | 14.31 |
| Mar. 14, 2011 | 11:00 am | 2.8908 | 14.28 | 2.9009 | 14.42 | 2.9547 | 14.58 |
| Mar. 15, 2011 | 11:00 am | 2.8934 | 14.39 | 2.9035 | 14.52 | 2.9578 | 14.70 |
| Mar. 24, 2011 | 6:30 am | 2.9019 | 14.72 | 2.9130 | 14.89 | 2.9676 | 15.08 |
| Mar. 27, 2011 | 6:30 am | 2.9052 | 14.85 | 2.9165 | 15.03 | 2.9716 | 15.23 |
| Mar. 31, 2011 | 9:00 am | 2.9082 | 14.97 | 2.9198 | 15.16 | 2.9750 | 15.36 |
| Apr. 03, 2011 | 10:30 am | 2.9111 | 15.09 | 2.9228 | 15.28 | 2.9785 | 15.50 |
| Apr. 07, 2011 | 7:30 am | 2.9132 | 15.17 | 2.9249 | 15.36 | 2.9807 | 15.58 |
| Apr. 13, 2011 | 6:30 am | 2.9170 | 15.32 | 2.9287 | 15.51 | 2.9845 | 15.73 |
| Apr. 26, 2011 | 8:00 am | 2.9229 | 15.55 | 2.9351 | 15.76 | 2.9927 | 16.05 |
| May 04, 2011 | 2:00 pm | 2.9262 | 15.68 | 2.9382 | 15.89 | 2.9961 | 16.18 |

Using equation (1) above, in the foregoing example, having approximately 40.0% desiccant loading and a 28% theoretical maximum percent by weight adsorption of water by the desiccant, the maximum mass of water the samples could adsorb is 0.2833 g, 0.2840 g and 0.2888 g for S7, S8 and S9, respectively. The actual weight increase for each sample was 0.3934 g, 0.3997 g and 0.4139 g for S7, S8 and S9, respectively, which is a 38.88%, 39.41% and 40.13% by weight increase S7, S8 and S9, respectively.

### EXAMPLE 7

80 grams of calcium oxide (CaO) (Specialty Minerals Inc., Item No. 02-01392AH01) was added to 120 grams of a higher durometer liquid silicone rubber, i.e., 40 durometer, (Shin-Etsu Silicones, Product ID No. KE-2000-40A), and the two components were then mixed until they formed a uniform, i.e., homogeneous, first mixture. Then, 80 grams of calcium oxide (CaO) (Specialty Minerals Inc., Item No. 02-01392AH01) was added to 120 grams of a higher durometer liquid silicone rubber (Shin-Etsu Silicones, Product ID No. KE-2000-40B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was then fed into a Liquid Injection Molding System having the following settings: injection rate=3 inches/second; cure time=60-80 seconds; and, hold temperature=400° F. Passing the final composition through the molding system and curing the composition at the hold temperature for the cure time resulted in the crosslinking of the silicone composition. Following crosslinking, the final composition was tested for water adsorption in an environment comprising approximately 80% relative humidity (RH). Table 7 below summarizes the water adsorption over several days for three samples having approximately 40% by weight CaO, i.e., S10, S11 and S12. The water adsorption is represented in the form of percent water by weight.

TABLE 7

| | Time of | Mass S10 | % Water | Mass S11 | % Water | Mass S12 | % Water |
|---|---|---|---|---|---|---|---|
| Date | day | (grams) | (% H₂O) | (grams) | (% H₂O) | (grams) | (% H₂O) |
| Feb. 17, 2011 | 7:30 am | 4.3791 | 0.00 | 3.3269 | 0.00 | 3.0917 | 0.00 |
| Feb. 17, 2011 | 2:00 pm | 4.4144 | 0.81 | 3.3581 | 0.94 | 3.1223 | 0.99 |
| Feb. 18, 2011 | 7:00 am | 4.5448 | 3.78 | 3.4777 | 4.53 | 3.2393 | 4.77 |
| Feb. 22, 2011 | 9:30 am | 4.8863 | 11.58 | 3.7160 | 11.70 | 3.4532 | 11.69 |
| Feb. 23, 2011 | 7:30 am | 4.8941 | 11.76 | 3.7225 | 11.89 | 3.4591 | 11.88 |
| Feb. 24, 2011 | 10:30 am | 4.8994 | 11.88 | 3.7288 | 12.08 | 3.4648 | 12.07 |
| Feb. 28, 2011 | 9:00 am | 4.9189 | 12.33 | 3.7526 | 12.80 | 3.4870 | 12.79 |
| Mar. 01, 2011 | 6:30 am | 4.9247 | 12.46 | 3.7570 | 12.93 | 3.4912 | 12.92 |
| Mar. 02, 2011 | 8:30 am | 4.9315 | 12.61 | 3.7614 | 13.06 | 3.4956 | 13.06 |
| Mar. 07, 2011 | 9:30 am | 4.9519 | 13.08 | 3.7752 | 13.48 | 3.5080 | 13.47 |
| Mar. 08, 2011 | 1:30 pm | 4.9558 | 13.17 | 3.7789 | 13.59 | 3.5114 | 13.58 |
| Mar. 09, 2011 | 8:30 am | 4.9572 | 13.20 | 3.7800 | 13.62 | 3.5121 | 13.60 |
| Mar. 14, 2011 | 11:00 am | 4.9681 | 13.45 | 3.7878 | 13.85 | 3.5207 | 13.88 |
| Mar. 15, 2011 | 11:00 am | 4.9709 | 13.51 | 3.7907 | 13.94 | 3.5233 | 13.96 |
| Mar. 24, 2011 | 6:30 am | 4.9857 | 13.85 | 3.8022 | 14.29 | 3.5349 | 14.34 |
| Mar. 28, 2011 | 6:30 am | 4.9925 | 14.01 | 3.8081 | 14.46 | 3.5408 | 14.53 |
| Mar. 31, 2011 | 9:00 am | 4.9976 | 14.12 | 3.8118 | 14.58 | 3.5447 | 14.65 |
| Apr. 03, 2011 | 10:30 am | 5.0025 | 14.24 | 3.8168 | 14.73 | 3.5493 | 14.80 |
| Apr. 07, 2011 | 7:30 am | 5.0056 | 14.31 | 3.8199 | 14.82 | 3.5527 | 14.91 |
| Apr. 13, 2011 | 6:30 am | 5.0127 | 14.47 | 3.8253 | 14.98 | 3.5579 | 15.08 |
| Apr. 26, 2011 | 8:00 am | 5.0230 | 14.70 | 3.8334 | 15.22 | 3.5660 | 15.34 |
| May 04, 2011 | 2:00 pm | 5.0317 | 14.90 | 3.8407 | 15.44 | 3.5724 | 15.55 |

Using equation (1) above, in the foregoing example, having approximately 40.0% desiccant loading and a 28% theoretical maximum percent by weight adsorption of water by the desiccant, the maximum mass of water the samples could adsorb is 0.4905 g, 0.3726 g and 0.3463 g for S10, S11 and S12, respectively. The actual weight increase for each sample was 0.6526 g, 0.5138 g and 0.4807 g for S10, S11 and S12, respectively, which is a 37.26%, 38.61% and 38.87% by weight increase S10, S11 and S12, respectively. 40.13% by weight increase S7, S8 and S9, respectively.

### EXAMPLE 8

80 grams of calcium oxide (CaO) (Specialty Minerals Inc., Item No. 02-01392AH01) was added to 120 grams of liquid silicone having a 20 durometer, (Shin-Etsu Silicones, Product ID No. KE-1950-20A), and the two components were then mixed until they formed a uniform, i.e., homogeneous, first mixture. Then, 80 grams of calcium oxide (CaO) (Specialty Minerals Inc., Item No. 02-01392AH01) was added to 120 grams of liquid silicone having a 20 durometer (Shin-Etsu Silicones, Product ID No. KE-1950-20B), and the two components were then mixed until they formed a uniform, i.e., homogeneous, second mixture. Next, the first and second uniform mixtures were combined and mixed until they formed a uniform, i.e., homogenous, composition, that when heated cures to form a silicone elastomer. The final uniform composition was then fed into a Liquid Injection Molding System having the following settings: injection rate=3 inches/second; cure time=60-80 seconds; and, hold temperature=400° F. Passing the final composition through the molding system and curing the composition at the hold temperature for the cure time resulted in the crosslinking of the silicone composition. Following crosslinking, the final composition was tested for water adsorption in an environment comprising approximately 80% relative humidity (RH). Table 8 below summarizes the water adsorption over several days for three samples having approximately 40% by weight CaO, i.e., S13, S14 and S15. The water adsorption is represented in the form of percent water by weight.

TABLE 8

| | Time of | Mass S13 | % Water | Mass S14 | % Water | Mass S15 | % Water |
|---|---|---|---|---|---|---|---|
| Date | day | (grams) | (% H₂O) | (grams) | (% H₂O) | (grams) | (% H₂O) |
| Feb. 17, 2011 | 1:30 pm | 3.6813 | 0.00 | 4.1162 | 0.00 | 4.4309 | 0.00 |
| Feb. 18, 2011 | 7:00 am | 3.7720 | 2.46 | 4.2080 | 2.23 | 4.5273 | 2.18 |
| Feb. 22, 2011 | 9:30 am | 4.1056 | 11.53 | 4.5828 | 11.34 | 4.9194 | 11.02 |
| Feb. 23, 2011 | 7:30 am | 4.1201 | 11.92 | 4.6028 | 11.82 | 4.9481 | 11.67 |
| Feb. 24, 2011 | 10:30 am | 4.1277 | 12.13 | 4.6115 | 12.03 | 4.9608 | 11.96 |
| Feb. 28, 2011 | 9:00 am | 4.1424 | 12.53 | 4.6268 | 12.40 | 4.9774 | 12.33 |
| Mar. 01, 2011 | 6:30 am | 4.1471 | 12.65 | 4.6308 | 12.50 | 4.9806 | 12.41 |
| Mar. 02, 2011 | 8:30 am | 4.1527 | 12.81 | 4.6351 | 12.61 | 4.9858 | 12.52 |
| Mar. 07, 2011 | 9:30 am | 4.1751 | 13.41 | 4.6572 | 13.14 | 5.0057 | 12.97 |
| Mar. 08, 2011 | 1:30 pm | 4.1813 | 13.58 | 4.6651 | 13.34 | 5.0133 | 13.14 |
| Mar. 09, 2011 | 8:30 am | 4.1826 | 13.62 | 4.6676 | 13.40 | 5.0159 | 13.20 |
| Mar. 14, 2011 | 11:00 am | 4.1944 | 13.94 | 4.6793 | 13.68 | 5.0299 | 13.52 |
| Mar. 15, 2011 | 11:00 am | 4.1981 | 14.04 | 4.6834 | 13.78 | 5.0339 | 13.61 |
| Mar. 24, 2011 | 6:30 am | 4.2080 | 14.31 | 4.6929 | 14.01 | 5.0432 | 13.82 |
| Mar. 28, 2011 | 6:30 am | 4.2132 | 14.45 | 4.6973 | 14.12 | 5.0487 | 13.94 |
| Mar. 31, 2011 | 9:00 am | 4.2177 | 14.57 | 4.7012 | 14.21 | 5.0522 | 14.02 |
| Apr. 03, 2011 | 10:30 am | 4.2222 | 14.69 | 4.7064 | 14.34 | 5.0570 | 14.13 |
| Apr. 07, 2011 | 7:30 am | 4.2245 | 14.76 | 4.7078 | 14.37 | 5.0593 | 14.18 |
| Apr. 13, 2011 | 6:30 am | 4.2301 | 14.91 | 4.7128 | 14.49 | 5.0641 | 14.29 |
| Apr. 26, 2011 | 8:00 am | 4.2388 | 15.14 | 4.7213 | 14.70 | 5.0739 | 14.51 |
| May 04, 2011 | 2:00 pm | 4.2436 | 15.27 | 4.7253 | 14.80 | 5.0785 | 14.62 |

Using equation (1) above, in the foregoing example, having approximately 40.0% desiccant loading and a 28% theoretical maximum percent by weight adsorption of water by the desiccant, the maximum mass of water the samples could adsorb is 0.4123 g, 0.4610 g and 0.4963 g for S13, S14 and S15, respectively. The actual weight increase for each sample was 0.5623 g, 0.6091 g and 0.6476 g for S13, S14 and S15, respectively, which is a 38.19%, 36.99% and 36.54% by weight increase S13, S14 and S15, respectively.

### EXAMPLE 9

A variety of compositions were made using molecular sieve and a two-part silicone polymer. Table 9 below sets forth the various ratios of molecular sieve to silicone component. It should be understood that for each ratio, the same amount of molecular sieve was mixed with each of the two components that make up the silicone polymer. The molecular sieve used in this example was UOP Type 13x Molecular Sieve (Advanced Specialty Glass Equipment, Item No. POW-200, Lot No. 2011009852), and the silicone polymer components used were Shin-Etsu Silicones, Product ID Nos. KE-2004-10A and KE-2004-10B.

TABLE 9

| % wt Molecular | Molecular | Silicone Polymer |
|---|---|---|
| Sieve | Sieve (grams) | Component (grams) |
| 10 | 37.33 | 335 |
| 15 | 59.12 | 335 |
| 20 | 83.75 | 335 |
| 25 | 111.70 | 335 |
| 30 | 143.60 | 335 |
| 40 | 223.30 | 335 |

Each of the foregoing quantities of molecular sieve were mixed with the above listed quantities of silicone polymer components. The mixing was performed in accordance with the procedures described above, i.e., the quantity of molecule sieve was mixed with the quantity of the silicone polymer component Part A until homogeneously dispersed therein, the quantity of molecule sieve was mixed with the quantity of the silicone polymer component Part B until homogeneously dispersed therein, and last the two blended compositions were combined until homogeneously mixed. The foregoing samples were not able to be run through a liquid injection molding system as the presence of the molecular sieve accelerated the crosslinking reaction of the silicone polymer components.

### EXAMPLE 10

Moisture adsorption as a percentage of part weight is significant in other resin sorbent compositions, e.g., nylon/molecular sieve and polypropylene/molecular sieve compositions. This may be seen in Table 10 below. In practice, molecular sieve will adsorb about 20% of its own weight. It is reasonable then to expect a 40% loaded polymer to adsorb 10% of its own weight. In the case of nylon, however, adsorption reaches 13% in a 90% relative humidity (RH) environment, while the capacity is closer to 10% in an 80% RH environment. This was presumably the result of the action of the sorbent coupled with adsorption of some water by the nylon itself. The fact that the body as a whole adsorbs in excess of 10% indicates that the sorbent was fully functional as a sorbent even though dispersed in the polymer. Polypropylene is hydrophobic and is thus much slower to adsorb moisture. Table 10 shows results of adsorption at 36-38% molecular sieve loading in nylon and polypropylene.

TABLE 10

| Moisture Adsorption | | | | |
|---|---|---|---|---|
| @ 29° C., 90% r.h. | 2 Days | 10 days | 23 days | 38 Days |
| Molecular Sieve | 5.4% | 12.4% | 13% | 13% |
| Reinforced Nylon | | | | |
| Molecular Sieve | 1.1% | 2.8% | 4.4% | 5.7% |
| Reinforced | | | | |
| Polypropylene | | | | |

In view of the foregoing, it can be seen that the present invention silicone resin or silicone rubber/elastomer with incorporated sorbents are effective at adsorbing environment moisture. Thus, the present invention method and composition can be used to form independent articles, or in the alternative, articles placed within other devices or enclosures, e.g., o-ring 10 or sealing insert 12 for use within a flip top container, whereby moisture present within the device or enclosure, or moisture surrounding the articles is adsorbed.

The present invention composition may be used in a device where a compliant material is needed which is also capable of adsorbing water. For example, air bag inflation device 14 having canister 16, igniter 18, propellant 20, e.g., sodium azide, and filter 22 may further include washer 24. Washer 24 can be formed from the present invention molding composition, thereby providing a compliant washer which adsorbs water vapor within the volume enclosed by canister 16.

Furthermore, in view of the foregoing, it should be appreciated that although silicone polymers do not act as water vapor barriers, such polymers when combined with at least one desiccant provide a means for rapid adsorption of water vapor within an enclosed volume. Silicone polymers are compliant and therefore provide a cushioning material. Although air encapsulation may occur during formation of the silicone polymers, the extent of encapsulation can be controlled by selection of mixing and/or molding techniques. As it is believed that the rate of water adsorption is dependent upon the extent of air encapsulation, the silicone polymer with desiccant can be customized to a required adsorption rate. For example, a faster adsorption rate can be provided by intentionally introducing air into the polymer. Additionally, adsorption rate can be controlled by the selection of desiccant material. For example, it has been found that molecular sieve adsorbs water vapor faster than calcium oxide. Further, although the foregoing description has primarily included a discussion of water adsorbing desiccants, other sorbents may also be used in the present invention, e.g., oxygen, volatile organic compound, ethylene or hexanol sorbents, and such sorbents are also within the spirit and scope of the present invention.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A molded article comprising:
a blend of a self supporting silicone polymer and a sorbent, wherein the sorbent is homogeneously dispersed within the silicone polymer.

2. The molded article of claim 1 wherein the silicone polymer is a resin or an elastomer.

3. The molded article of claim 1 wherein the sorbent is a molecular sieve, a silica gel, an ion exchange resin, an activated carbon, an activated alumina, a clay, a zeolite, a particulate metal, a salt comprising a CO₂ releasing anion, calcium oxide or a mixture thereof.

4. The molded article of claim 1 wherein the sorbent is calcium oxide.

5. The molded article of claim 1 wherein the blend comprises from about five percent (5%) to about fifty-five percent (55%) sorbent and from about forty-five (45%) to about ninety-five (95%) silicone polymer.

6. The molded article of claim 1 wherein the blend comprises from about ten percent (10%) to about forty percent (40%) sorbent and from about sixty (60%) to about ninety (90%) silicone polymer.

7. The molded article of claim 1 wherein the article is a gasket, a seal or an insert.

8. The molded article of claim 1 wherein the silicone polymer comprises an alkyl silicone polymer and a vinyl silicone polymer.

9. A molding composition comprising:
a silicone component; and,
a sorbent, wherein the sorbent is homogeneously dispersed within the silicone component.

10. The molding composition of claim 9 wherein the silicone component is a fluid, a resin or an elastomer.

11. The molding composition of claim 9 wherein the sorbent is a molecular sieve, a silica gel, an ion exchange resin, an activated carbon, an activated alumina, a clay, a zeolite, a particulate metal, a salt comprising a CO₂ releasing anion, calcium oxide or a mixture thereof.

12. The molding composition of claim 9 wherein the sorbent is calcium oxide.

13. The molding composition of claim 9 wherein the composition comprises from about five percent (5%) to about fifty-five percent (55%) sorbent and from about forty-five (45%) to about ninety-five (95%) silicone component.

14. The molding composition of claim 9 wherein the composition comprises from about ten percent (10%) to about forty percent (40%) sorbent and from about sixty (60%) to about ninety (90%) silicone component.

15. The molding composition of claim 9 wherein the silicone component comprises an alkyl silicone polymer and a vinyl silicone polymer.

16. A method of forming a molding composition comprising a silicone polymer and a sorbent, wherein the silicone polymer comprises a first silicone material and a second silicone material, the first silicone material being different than the second silicone material, the method comprising the steps of:
a) blending the first silicone material and the sorbent into a first blended composition, wherein the sorbent is homogeneously dispersed within the first silicone material;
b) blending the second silicone material and the sorbent into a second blended composition, wherein the sorbent is homogeneously dispersed within the second silicone material; and,
c) blending the first and second blended composition to form the molding composition, wherein the sorbent is homogeneously dispersed within the molding composition and the molding composition is heat curable.

17. The method of claim 16 wherein the first silicone material is an alkyl silicone polymer and the second silicone material is a vinyl silicone polymer.

18. The method of claim 16 wherein the silicone polymer is a fluid, a resin or an elastomer.

19. The method of claim 16 wherein the sorbent is a molecular sieve, a silica gel, an ion exchange resin, an activated carbon, an activated alumina, a clay, a zeolite, a particulate metal, a salt comprising a CO₂ releasing anion, calcium oxide or a mixture thereof.

20. The method of claim 16 wherein the sorbent is calcium oxide.

21. The method of claim 16 wherein the molding composition comprises from about five percent (5%) to about fifty-five percent (55%) sorbent and from about forty-five (45%) to about ninety-five (95%) silicone polymer

22. The method of claim 16 wherein the molding composition comprises from about ten percent (10%) to about forty percent (40%) sorbent and from about sixty (60%) to about ninety (90%) silicone polymer.
